(19) United States
(12) Patent Application Publication
(10) Pub. No.: US 2024/0190523 A1
(43) Pub. Date: Jun. 13, 2024

(54) METHOD AND DEVICE FOR DETERMINING POTENTIAL DAMAGE OF AN ENDLESS TRACK OF A TRACKED VEHICLE

(71) Applicant: BAE Systems Hägglunds Aktiebolag, Örnsköldsvik (SE)

(72) Inventor: Andreas ROWA, Bonässund (SE)

(73) Assignee: BAE Systems Hägglunds Aktiebolag, Örnsköldsvik (SE)

(21) Appl. No.: 18/287,833

(22) PCT Filed: Apr. 20, 2022
(86) PCT No.: PCT/SE2022/050383

§ 371 Date: Oct. 20, 2023

(30) Foreign Application Priority Data
Apr. 23, 2021 (SE) 2150512-8

(51) Int. Cl. B62D 55/253; B62D 55/30; G01M 13/045; G01M 17/03

(52) U.S. Cl. CPC B62D 55/253; B62D 55/305; G01M 13/045; G01M 17/03

(57) ABSTRACT

Disclosed is a method and device for determining potential damage of an endless track of a tracked vehicle. Said vehicle comprises at least one track assembly comprising a drive wheel member, a tension wheel member, a set of road wheels and said endless track disposed around said wheels. Said endless track is rotated by means of said drive wheel member during drive. The method comprises the steps of: receiving, from at least one sensor, measurement information associated with vibrations of said endless track; based on the information received from said at least one sensor, determining if there is a natural frequency of said endless track and if so determining the natural frequency of said endless track; and, based on the determination associated with natural frequency, determining whether there is a potential damage to the endless track.

### CROSS-REFERENCE TO RELATED APPLICATIONS

This application is a U.S. national stage application under 35 U.S.C. § 371 of International Application No. PCT/SE2022/050383, filed Apr. 20, 2022, which claims the priority of SE Application No. 2150512-8, filed Apr. 23, 2021. The entire contents of each priority application is incorporated herein by reference.

### FIELD OF THE DISCLOSURE

The present invention relates to a method for determining potential damage of an endless track of a tracked vehicle. The present invention also relates to a method for determining potential damage of an endless track of a tracked vehicle. The present invention also relates to a tracked vehicle. The present invention in addition relates to a computer program and a computer program product.

### BACKGROUND OF THE DISCLOSURE

Tracked vehicles may be equipped with opposite track assemblies. Each track assembly comprises an endless track arranged to run in a longitudinal extension over a set of wheels comprising a drive wheel member, a tension wheel member and a set of road wheels there between. Said endless track is configured to be rotated by means of said drive wheel member during drive of the tracked vehicle.

Such endless tracks may be endless tracks of a rubber material and comprising a wire configuration arranged within said endless track and configured to run in the longitudinal extension of said endless track around said endless track.

Such tracked vehicles, e.g. combat vehicles, are intended to be driven in rough terrain, which may increase the risk of damage of an endless track of the tracked vehicle. Broken wires may result in said endless track being torn apart. Determination of potential damage to an endless track may be performed by visual control, looking at e.g. degree of visual damage. This is however not a fully reliable method due to the fact that also non-visual damage may result in severe damage on the endless track with the risk of said endless track being torn apart.

There is thus a need for improving determining potential damage of an endless track of a tracked vehicle.

### OBJECTS OF THE INVENTION

An object of the present invention is to provide a method for determining potential damage of an endless track of a tracked vehicle.

Another object of the present invention is to provide a device for determining potential damage of an endless track of a tracked vehicle.

Another object of the present invention is to provide a tracked vehicle comprising such a device.

Yet another object of the present invention is to provide a computer program for performing said method and a computer program product for storing the computer program.

### SUMMARY OF THE DISCLOSURE

These and other objects, apparent from the following description, are achieved by a method, a device, a tracked vehicle, a computer program and a computer program product, as set out in the appended independent claims. Preferred embodiments of the method and the device are defined in appended dependent claims.

According to an aspect of the present disclosure there is provided a method for determining potential damage of an endless track of a tracked vehicle. Said tracked vehicle comprises at least one track assembly comprising a drive wheel member, a tension wheel member, a set of road wheels and said endless track disposed in its longitudinal extension around said wheels. Said endless track is configured to be rotated by means of said drive wheel member during drive of the tracked vehicle. The method comprises the step of receiving, from at least one sensor, measurement information associated with vibrations of said endless track. The method further comprises the step of, based on the information received from said at least one sensor, determining if there is a natural frequency of said endless track and if so determining the natural frequency of said endless track. The method further comprises the step of, based on the determination associated with natural frequency, determining whether or not there is a potential damage to the endless track.

Hereby a safe and reliable method of determining potential damage of an endless track of a tracked vehicle is facilitated. Hereby broken, i.e. torn apart, wires/wire portions within an endless track may be detected, even without any obvious visual damage on said endless track. Hereby severe damage to the endless track so that the endless track is torn apart may be avoided, since degree of damage, including non-visual damage, of said endless track may be discovered prior to the risk of severe damage which may result in the endless track being torn apart. The natural frequency of an endless track, in the longitudinal direction of said track, of a tracked vehicle is essentially independent of weight of the tracked vehicle and tension of the endless track, thus increasing the reliability of said method.

If a natural frequency of said endless track is determined, based on the information received from said at least one sensor, it is determined whether or not there is a potential damage to the endless track based on the thus determined natural frequency. If it is determined that there is no natural frequency of said endless track, i.e. said at least one sensor has detected no natural frequency, based on the information received from said at least one sensor, potential damage to the endless track may be determined based on the thus determined lack of natural frequency of said endless track. According to an aspect of the present disclosure, the step of determining if there is a natural frequency of said endless track and if so determining the natural frequency of said endless track, refers to determining that a natural frequency or no natural frequency has been detected by means of said at least one sensor.

According to an aspect of said method, the step of determining if there is a natural frequency of said endless track, and if so, determining the natural frequency of said endless track comprises determining if there is a natural frequency of said endless track, and if so, determining the natural frequency in the longitudinal extension of said endless track. Hereby natural frequency may be efficiently determined, since the endless track has a longitudinal natural frequency, which depends on the longitudinal stiffness of the endless track.

According to an aspect of said method, said endless track comprises a wire configuration arranged within said endless track and configured to run in the longitudinal extension of said endless track around said endless track. Said wire configuration provides and/or contributes to the stiffness of said endless track, wherein a broken wire/wire portion of said wire configuration may change the stiffness of said endless track. Said wire configuration provides and/or contributes to the stiffness of said endless track in the longitudinal direction, wherein a broken wire/wire portion of said wire configuration may change the stiffness of said endless track in the longitudinal direction. The natural frequency of said endless track is thus associated with said wire configuration providing/contributing to the stiffness of said endless track. Said wire configuration may according to an aspect of the present disclosure be a wire configured to run within said endless track a number of laps within and around said endless track such that a number of wire portions are running within said endless track adjacent to each other so as to provide an increased stiffness of said endless track. Should said wire configuration be broken such that portions of the wire at one or more laps are broken, there will be a reduction of said natural frequency compared to a none-broken state of said wire configuration. Alternatively said wire configuration, according to an aspect of the present disclosure may comprise a set of individual wires arranged to run one or more laps within said endless track and be arranged adjacent to each other. Should said wire configuration be broken such that one or more wires are broken, there will be a reduction of said natural frequency compared to a none-broken state of said wire configuration. Broken/torn apart wire/wire portions changes the stiffness in the longitudinal direction and hence the natural frequency of said endless track. Thus, the step of, based on the determination associated with natural frequency, determining whether or not there is a potential damage to the endless track may comprise determining whether or not there is a damage to said wire configuration. According to an aspect of the present disclosure, the step of, based on the determination associated with natural frequency, determining whether or not there is a potential damage to the endless track may comprise determining whether or not there is a damage to said wire configuration and also the extent to which said wire configuration is damaged. Hereby the degree of damage to the endless track may be determined so as to facilitate determining whether or not the tracked vehicle should be driven. Hereby the degree of damage to the wire configuration and hence the endless track may be determined so as to facilitate determining whether or not the tracked vehicle should be driven based on estimated number of wire portions/wires of said wire configuration being broken.

According to an aspect of said method, the step of determining whether or not there is a potential damage to the endless track comprises the steps of: comparing the determination associated with natural frequency of said endless track with a predetermined natural frequency associated with said endless track: and, determining a potential damage to the endless track if the difference between said determination associated with natural frequency and said predetermined natural frequency exceeds a predetermined threshold. Hereby an efficient and reliable way of determining potential damage to said endless track is provided. Said predetermined natural frequency may be determined in any suitable way. Said predetermined natural frequency may be determined for an endless track of the same type for the same kind of vehicle, which endless track is non-damaged. According to an aspect of the present disclosure the method for determining the predetermined natural frequency may be the same method as said method for determining if there is a natural frequency of said endless track and if so determining the natural frequency of said endless track.

According to an aspect of said method, the step of receiving, from said at least one sensor, measurement information associated with vibrations of said endless track comprises receiving measurement information from measurement of movement of crankshaft of tension wheel member, and based on said crankshaft movement determining if there is a natural frequency of said endless track, and if so, determining the natural frequency. Hereby a safe and reliable method of determining potential damage of an endless track of a tracked vehicle is facilitated. By thus utilizing the existing crankshaft of the tension wheel member and detecting movements, said measurement information associated with vibrations of said endless track may be easily and efficiently provided. According to an aspect of the present disclosure, said possible natural frequency is provided through filtering based on said detected crankshaft movement. Said at least one sensor for detecting the crankshaft movement is according to a variant an accelerometer.

According to an aspect of said method, the step of receiving, from said at least one sensor, measurement information associated with vibrations of said endless track comprises receiving measurement information from measurement of pressure variation of a tension cylinder in connection to said tension wheel member of said track assembly, and based on said pressure variation determining if there is a natural frequency of said endless track, and if so, determining the natural frequency. Hereby a safe and reliable method of determining potential damage of an endless track of a tracked vehicle is facilitated. By thus utilizing the existing tension cylinder of the tension wheel member and detecting movements, said measurement information associated with vibrations of said endless track may be easily and efficiently provided. According to an aspect of the present disclosure, said possible natural frequency is provided through filtering based on said detected pressure variation of a tension cylinder. Said at least one sensor for detecting the pressure variation of a tension cylinder is according to a variant a pressure sensor.

According to an aspect of said method, the step of receiving, from said at least one sensor, measurement information associated with vibrations of said endless track comprises receiving measurement information from measurements performed during a drive sweep of said tracked vehicle, said drive sweep comprising driving said vehicle at a lower speed of said tracked vehicle followed by a higher speed, said higher speed being higher than said lower speed, said higher speed being followed by said lower speed. By thus performing measurement during such a drive sweep, an efficient and reliable method of determining potential damage of an endless track of a tracked vehicle is facilitated. Said lower speed and higher speed are speeds within in a range where natural frequency may be determined by means of measurements performed during such a drive sweep.

According to an aspect of said method, the step of receiving measurement information from measurements performed during a drive sweep relates to a drive sweep performed on predetermined solid ground having a relatively hard and even surface configured to support said tracked vehicle. According to an aspect of said method, the step of receiving measurement information from measurements performed during a drive sweep relates to a drive sweep performed on predetermined solid ground having an even surface configured to support said tracked vehicle. Said solid ground with even surface is such that the movement of the vehicle is such that measurements performed during such a drive sweep is not interfered by undesired movement of the vehicle. Said solid ground with even surface is such that the movement of the vehicle is such that measurements associated with determination of natural frequency performed during such a drive sweep is not interfered by undesired movement of the vehicle due to the natural frequency being extinguished caused by such undesired movement. By thus performing measurement during such a drive sweep on solid ground with even surface, an efficient and reliable method of determining potential damage of an endless track of a tracked vehicle is facilitated. Solid ground refers to a ground configured to fully support the tracked vehicle, e.g. asphalt, concreate or the like, so that the vehicle, during drive on said solid ground, is essentially not subjected to any disturbances in its movement in the intended drive direction. Such disturbances in the movement of the tracked vehicle during drive of the vehicle may refer to movements in a direction essentially orthogonal to the longitudinal and transversal extension of the vehicle, caused e.g. by bumps, oscillations or the like. Even surface refers to a surface not having any substantial unevenness such as bumps, cavities or the like, so that the vehicle, during drive on said solid ground, is essentially not subjected to any disturbances in its movement in the intended drive direction. Such disturbances in the movement of the tracked vehicle during drive of the vehicle may refer to movements in a direction essentially orthogonal to the longitudinal and transversal extension of the vehicle, caused e.g. by bumps, oscillations or the like.

According to an aspect of said method, the step of receiving, from said at least one sensor, measurement information associated with vibrations of said endless track comprises receiving measurement information from measurements performed during a first standstill position of said tracked vehicle, during which first standstill position an external trigger frequency is applied in connection to said track assembly. Said first standstill position refers to a standstill position of the tracked vehicle where a first portion of said endless track is engaged with the ground. Said first standstill position refers to a standstill position of the tracked vehicle where a first portion of said endless track, comprising portions of a wire configuration configured to run in the longitudinal extension of said endless track around said endless track, is engaged with the ground. According to an aspect of the present disclosure, where said endless track comprises a wire configuration, should one or more wires/wire portions of the wire of the endless track not being engaged with the ground in said first standstill be broken, a lower natural frequency would be expected when an external trigger frequency is applied in connection to said track assembly, so that, when receiving measurement information from measurements performed during said first standstill position of said tracked vehicle, a potential damage to said endless track may be determined. By thus performing measurement during such a first standstill, an efficient and reliable method of obtaining measurement information associated with vibrations of said endless is facilitated.

According to an aspect of said method, the step of receiving, from said at least one sensor, measurement information associated with vibrations of said endless track comprises receiving measurement information from measurements performed during a second standstill position, which follows said first standstill position, wherein said tracked vehicle has been moved from said first standstill position to said second standstill position such that the endless track has been rotated so that the portion of the endless track currently engaged with the ground is moved so that it, in said second standstill position, is no longer engaged with the ground of said tracked vehicle, during which second standstill said external trigger frequency is applied in connection to said track assembly. The phrase “ . . . so that the portion of the endless track currently engaged with the ground is moved so that it . . . ” thus refers to “so that the portion of the endless track engaged with the ground during said first standstill position is moved so that it . . . ”. Said second standstill position refers to a standstill position of the tracked vehicle where a second portion of said endless track, different from said first portion of said endless track, is engaged with the ground. Said second standstill position refers to a standstill position of the tracked vehicle where a second portion of said endless track, comprising portions of a wire configuration configured to run in the longitudinal extension of said endless track around said endless track, is engaged with the ground. According to an aspect of the present disclosure, where said endless track comprises a wire configuration, should one or more wires/wire portions of the wire configuration of the endless track being engaged with the ground in said first standstill be broken, a lower natural frequency would be expected when an external trigger frequency is applied in connection to said track assembly, when said tracked vehicle has been moved to said second standstill position, when receiving measurement information from measurements performed during said second standstill position of said tracked vehicle, a potential damage to said endless track may be determined. Thus, a difference between the natural frequency thus detected by applying such external trigger frequency in a first standstill and in a second standstill may indicate potential damage to said endless track, and also which portion of said endless track. By thus performing measurement during such a second standstill after such a first standstill, an efficient and reliable method of determining potential damage of an endless track of a tracked vehicle is facilitated.

According to an aspect of said method, the step of receiving measurement information from measurements performed during said first and second standstills comprises measurements performed during application of said external trigger frequency by pulsating hydraulic pressure in a tension cylinder in connection to said tension wheel member of said track assembly, said pulsation of hydraulic pressure being within a predetermined frequency sweep from a relatively lower frequency to a relatively higher frequency, said higher frequency being higher than said lower frequency, and back to said relatively lower frequency. By thus performing measurement during such a first and second standstill by pulsating hydraulic pressure in said tension cylinder within such a predetermined frequency sweep, an efficient and reliable method of obtaining measurement information associated with vibrations of said endless is facilitated, and hence an efficient and reliable method of determining potential damage of an endless track of a tracked vehicle is facilitated. Said lower frequency and higher frequency are frequencies within in a range where natural frequency may be determined by means of measurements performed during application of said external trigger frequency.

According to an aspect of said method, the step of receiving measurement information from measurements performed during said first and second standstills comprises measurements performed during application of said external trigger frequency by generating oscillations by means of a mechanical device applied on said tension wheel member, said generated oscillations being within a predetermined frequency sweep from a relatively lower frequency to a relatively higher frequency, said higher frequency being higher than said lower frequency, and back to said relatively lower frequency. By thus performing measurement during such a first and second standstill by generating oscillations by means of a mechanical device applied on said tension wheel member, with said generated oscillations being within such a predetermined frequency sweep, an efficient and reliable method of obtaining measurement information associated with vibrations of said endless is facilitated, and hence an efficient and reliable method of determining potential damage of an endless track of a tracked vehicle is facilitated. Said lower frequency and higher frequency are frequencies within in a range where natural frequency may be determined by means of measurements performed during application of said external trigger frequency.

According to another aspect of the present disclosure there is provided a device for determining potential damage of an endless track of a tracked vehicle. Said tracked vehicle comprises at least one track assembly comprising a drive wheel member, a tension wheel member, a set of road wheels and said endless track disposed in its longitudinal extension around said wheels. Said endless track is configured to be rotated by means of said drive wheel member during drive of the tracked vehicle. Said device comprises at least one sensor for obtaining measurement information associated with vibrations of said endless track, and at least one processor operatively connected to said at least one sensor. Said at least one processor is configured to receive, from said at least one sensor, measurement information associated with vibrations of said endless track. Said at least one processor is further configured to, based on the information received from said at least one sensor, determine if there is a natural frequency of said endless track and if so determine the natural frequency of said endless track. Said at least one processor is further configured to, based on the determination associated with natural frequency, determine whether or not there is a potential damage to the endless track.

According to an aspect of said device, said at least one processor is configured to determine if there is a natural frequency of said endless track, and if so, determining the natural frequency in the longitudinal extension of said endless track based on the information received from said at least one sensor.

According to an aspect of said device, said endless track comprises a wire configuration arranged within said endless track and configured to run in the longitudinal extension of said endless track around said endless track.

According to an aspect of said device, said at least one processor, when determining whether or not there is a potential damage to the endless track, is configured to compare the determination associated with natural frequency of said endless track with a predetermined natural frequency associated with said endless track: and, determine a potential damage to the endless track if the difference between said determination associated with natural frequency and said predetermined natural frequency exceeds a predetermined threshold.

According to an aspect of said device, said at least one processor, when receiving, from said at least one sensor, measurement information associated with vibrations of said endless track, is configured to receive information from measurement of movement of crankshaft of tension wheel member, and wherein the processor is configured to determine if there is a natural frequency of said endless track, and if so, determining the natural frequency based on said received information about crankshaft movement.

According to an aspect of said device, said at least one processor, when receiving, from said at least one sensor, measurement information associated with vibrations of said endless track, is configured to receive information from measurement of pressure variation of a tension cylinder in connection to said tension wheel member of said track assembly, and wherein the processor is configured to determine if there is a natural frequency of said endless track, and if so, determining the natural frequency based on said received information about pressure variation.

According to an aspect of said device, said at least one processor, when receiving, from said at least one sensor, measurement information associated with vibrations of said endless track, is configured to receive measurement information from measurements performed during a drive sweep of said tracked vehicle, said drive sweep comprising driving said vehicle at a lower speed followed by a higher speed, said higher speed being higher than said lower speed, said higher speed being followed by said lower speed.

According to an aspect of said device, said at least one processor, when receiving measurement information from measurements performed during said drive sweep, is configured to receive measurement information from measurements performed during said sweep performed on predetermined solid ground having a relatively hard and even surface configured to support said tracked vehicle.

According to an aspect of said device, said at least one processor, when receiving, from said at least one sensor, measurement information associated with vibrations of said endless track, is configured to receive measurement information from measurements performed during a first standstill position of said tracked vehicle, during which first standstill position an external trigger frequency is applied in connection to said track assembly.

According to an aspect of said device, said at least one processor, when receiving, from said at least one sensor, measurement information associated with vibrations of said endless track, is configured to receive measurement information from measurements performed during a second standstill position, which follows said first standstill position, wherein said tracked vehicle has been moved from said first standstill position to said second standstill position such that the endless track has been rotated so that the portion of the endless track engaged with the ground during said first standstill has been moved so that it, in said second standstill position, is no longer engaged with the ground of said tracked vehicle, during which second standstill said external trigger frequency is applied in connection to said track assembly.

According to an aspect of said device, said at least one processor, when receiving measurement information from measurements performed during said first and second standstills, is configured to receive said information when said external trigger frequency is configured to be applied in connection to said track assembly by means of pulsating hydraulic pressure in a tension cylinder in connection to said tension wheel member of said track assembly, where said pulsation of hydraulic pressure has been within a predetermined frequency sweep from a relatively lower frequency to a relatively higher frequency, said higher frequency being higher than said lower frequency, and back to said relatively lower frequency.

According to an aspect of said device, said at least one processor, when receiving measurement information from measurements performed during said first and second standstills, is configured to receive said information when said external trigger frequency is configured to be applied in connection to said track assembly by means of generating oscillations by means of a mechanical device applied on said tension wheel member, where said generated oscillations have been within a predetermined frequency sweep from a relatively lower frequency to a relatively higher frequency and back to said relatively lower frequency.

The device for determining potential damage of an endless track of a tracked vehicle according to the present disclosure has the advantages according to the corresponding method as set out herein.

According to yet another aspect of the present disclosure there is provided a tracked vehicle comprising a device as set out herein.

According to yet another aspect of the present disclosure there is provided a computer program comprising computer-readable instructions which, when executed by at least one processor of a device as set out herein for determining potential damage of an endless track of a tracked vehicle, causes the at least one processor to perform any of, or any combination of, the method steps of the above described method.

According to yet another aspect of the present disclosure there is provided a computer program product comprising at least one computer-readable medium, such as a non-volatile memory, storing the above mentioned computer program.

### BRIEF DESCRIPTION OF THE FIGURES

For a better understanding of the present disclosure reference is made to the following detailed description when read in conjunction with the accompanying drawings, wherein like reference characters refer to like parts throughout the several views, and in which:

FIG. 1 schematically illustrates a side view of a tracked vehicle according to an embodiment of the present disclosure:

FIG. 2 schematically illustrates a perspective view of a track assembly of a tracked vehicle according to an embodiment of the present disclosure;

FIG. 3 schematically illustrates a perspective view of a portion of the track assembly in FIG. 2 according to an embodiment of the present disclosure:

FIG. 4 schematically illustrates a plan view of a tracked vehicle according to an embodiment of the present disclosure:

FIG. 5 schematically illustrates a block diagram of a control device for controlling steering of a tracked vehicle according to an embodiment of the present disclosure:

FIG. 6 schematically illustrates a flowchart of a method for determining potential damage of an endless track of a tracked vehicle according to an embodiment of the present disclosure; and

FIG. 7 schematically illustrates a flowchart of a method for determining potential damage of an endless track of a tracked vehicle according to an embodiment of the present disclosure.

### DETAILED DESCRIPTION OF THE DISCLOSURE

Hereinafter the term “link” refers to a communication link which may be a physical connector, such as an optoelectronic communication wire, or a non-physical connector such as a wireless connection, for example a radio or microwave link.

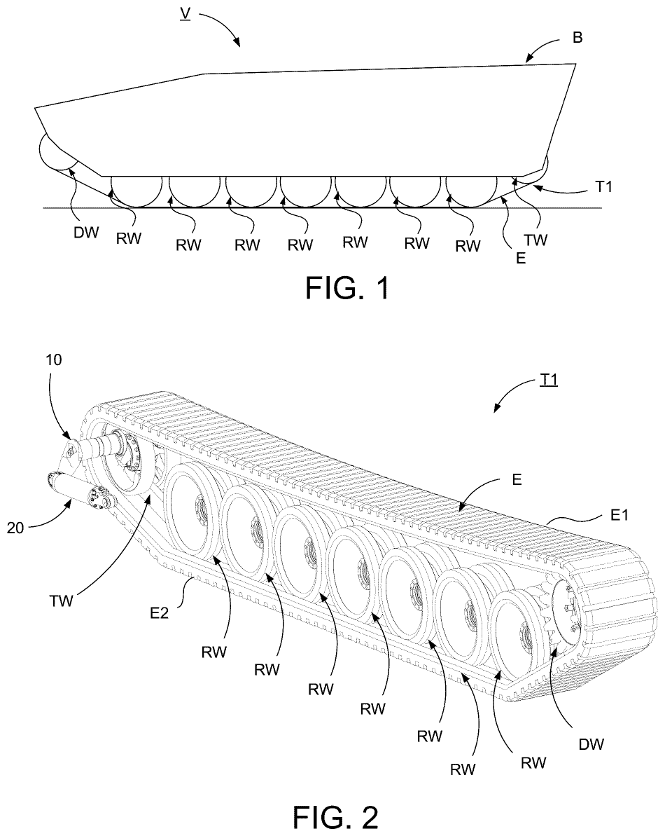

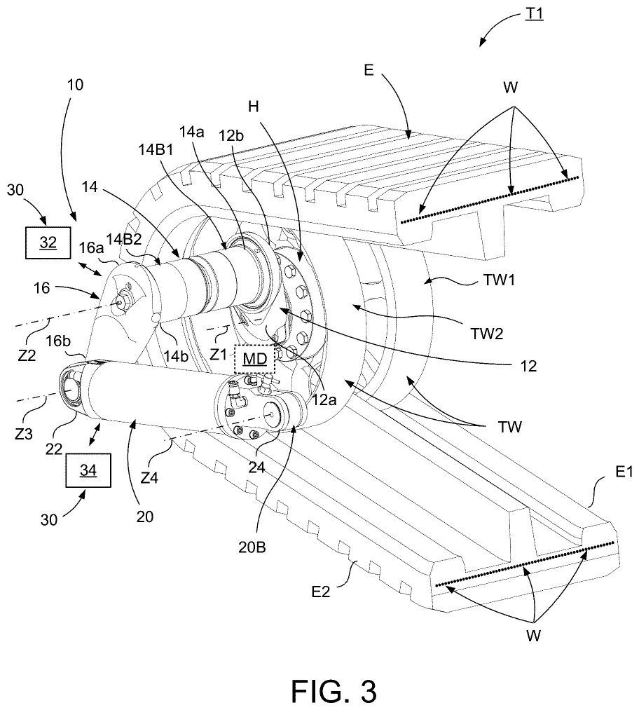

FIG. 1 schematically illustrates a side view of a tracked vehicle V according to an embodiment of the present disclosure. FIG. 2 schematically illustrates a perspective view of a track assembly T1 of a tracked vehicle, e.g. a tracked vehicle according to FIG. 1, according to an embodiment of the present disclosure. FIG. 3 schematically illustrates a perspective view of a portion of the track assembly T1 in FIG. 2 according to an embodiment of the present disclosure.

The tracked vehicle V is according to the disclosure in FIG. 1 a military vehicle. The tracked vehicle V is according to the disclosure in FIG. 1 a combat vehicle.

The tracked vehicle V comprises a vehicle body B, which according to an aspect of the present disclosure comprises the chassis of the vehicle V and bodywork.

The tracked vehicle V comprises a right track assembly T1 and a left track assembly for driving the vehicle V, the left track assembly being shown in FIG. 1. Each track assembly comprises a drive wheel member DW, a tension wheel member TW, a set of road wheels RW and an endless track E arranged to run over said wheels. Here the drive wheel member DW is arranged in the front, the tension wheel member TW is arranged in the back and the road wheels RW are arranged between the drive wheel member DW and the tension wheel member TW. The tracked vehicle according to the present disclosure may however have track assemblies with any suitable arrangement of drive wheel member, tension wheel member and road wheels. According to an aspect of the present disclosure the tension wheel member may be arranged in the front, the drive wheel member arranged in the back and the road wheels arranged there between. According to an aspect, the present disclosure relates to a fastening arrangement of a drive wheel DW for a track assembly.

The endless track E of the respective track assembly is arranged to be driven and hence rotated by means of said drive wheel member DW. The tracked vehicle V comprises a drive means, not shown, for driving said drive wheel members DW. The drive means may be any suitable drive means such as an internal combustion engine and/or an electric machine.

The endless track E of the respective track assembly T1 of the tracked vehicle V has an outer side E1 facing out from a vehicle in the transversal direction of the vehicle and an inner side E2 facing towards the vehicle in the transversal direction of the vehicle to which the track assembly is mounted, see FIG. 2 and FIG. 3.

According to an aspect of the present disclosure said tension wheel member TW is rotatably arranged about an axis Z1. Said axis Z1 is herein denoted the first axis Z1. According to an aspect of the present disclosure said tension wheel member TW comprises a hub member H. According to an aspect of the present disclosure said hub member H is coaxially arranged about said first axis Z1. According to an aspect of the present disclosure said tension wheel member TW comprises an outer tension wheel TW1 arranged in connection to an outer side of said hub member H and thus in connection to the outer side E1 of the endless track E. According to an aspect of the present disclosure said tension wheel member TW comprises an inner tension wheel TW2 arranged in connection to an inner side of said hub member H and thus in connection to the inner side E2 of the endless track E.

The endless track E of the respective track assembly may have any suitable configuration and be of any suitable material. The endless track E of the respective track assembly may, according to an aspect of the present disclosure, be a rubber track. The endless track of the respective track assembly may, according to an aspect of the present disclosure, be a steel track.

According to an aspect of the present disclosure, said tension wheel member TW comprises a crankshaft 10, see FIGS. 2 and 3. Said crankshaft 10 is configured to be arranged in connection to the inner side of said hub member H. Said crankshaft 10 is configured to connected to the hub member H and arranged in connection to the inner tension wheel TW2. Said crankshaft 10 is configured to project from the inner side of said hub member H and from the inner side E2 of the endless track E.

According to an aspect of the present disclosure, said crankshaft 10 comprises an outer lever 12 arranged closest to said hub member H. According to an aspect of the present disclosure, said outer lever 12 has a first end portion 12a and an opposite second end portion 12b. According to an aspect of the present disclosure, said outer lever 12 is configured to be attached to said hub member H at a fastening point in connection to said first end portion 12a so as to allow rotation of said outer lever 12 about said first axis Z1.

According to an aspect of the present disclosure, said crankshaft 10 comprises an axle 14. According to an aspect of the present disclosure, said axle 14 has an outer end portion 14a closest to said hub member H and an opposite inner end portion 14b. According to an aspect of the present disclosure, said axle 14 is configured to be connected, in connection to the outer end portion 14a, to said second end portion 12b of said outer lever 12. According to an aspect of the present disclosure, said axle 14 is configured to project from said outer end portion 14a to said inner end portion 14b in an axial direction Z2 parallel to said axial direction Z1, i.e. about a second axis Z2 having an extension parallel to said first axis Z1.

According to an aspect of the present disclosure, said axle 14 comprises a bearing configuration 14B1, 14B2 so as to facilitate allowing rotation of said axle 14 about said second axis Z2 relative to the vehicle body B of the tracked vehicle V. According to an aspect of the present disclosure, said bearing configuration 14B1, 14B2 is configured to be attached to the vehicle body B, i.e. chassis, of the tracked vehicle V so as to facilitate allowing rotation of said axle 14 about said second axis Z2 relative to the vehicle body B. According to an aspect of the present disclosure, said bearing configuration 14B1, 14B2 comprises an outer bearing member 14B1 arranged closer to the outer side portion 14a and an inner bearing member 14B2 arranged closer to the inner side portion 14b.

According to an aspect of the present disclosure, said crankshaft 10 comprises an inner lever 16. Said inner lever 16 has a first end portion 16a and an opposite second end portion 16b. According to an aspect of the present disclosure, said axle 14 is configured to be connected, in connection to its inner end portion 14b, to said first end portion 16a of said inner lever 16. According to an aspect of the present disclosure, said inner lever 16 is configured to be attached to said inner side portion 14b of said axle 14 so as to allow rotation of said inner lever 16 about said second axis Z2.

According to an aspect of the present disclosure, said tension wheel member TW comprises a tension cylinder 20, see FIGS. 2 and 3. According to an aspect of the present disclosure, said a tension cylinder 20 is configured to be arranged in connection to the inner tension wheel TW2. Said a tension cylinder 20 has a first end portion 22 and an opposite second end portion 24.

According to an aspect of the present disclosure, said a tension cylinder 20 is configured to be connected, in connection to its first end portion 22, to said second end portion 16b of said inner lever 16. According to an aspect of the present disclosure, said tension cylinder 20 is configured to be attached, in connection to its first end portion 22, at a connection point, to said second end portion 16b of said inner lever 16 so as to allow rotation of said tension cylinder 20 about a third axis Z3. Said third axis Z3 has an axial extension essentially parallel to the axial extension of said first axis Z1 and second axis Z2.

According to an aspect of the present disclosure, said tension cylinder 20 is configured to extend in the longitudinal extension of said endless track E, from its first end portion 22, in a direction away from the rear side of said endless track E, when said tension wheel member TW is arranged in the rear side.

According to an aspect of the present disclosure, said tension cylinder 20 comprises a bearing configuration 20B arranged in connection to its second end portion 24 so as to facilitate allowing rotation about a fourth axis Z4 relative to the vehicle body B of the tracked vehicle V. Said fourth axis Z4 has an axial extension essentially parallel to the axial extension of said first, second and third axis. According to an aspect of the present disclosure, said bearing configuration 20B is configured to be attached to the vehicle body B, i.e. chassis, of the tracked vehicle V so as to facilitate allowing rotation of said tension cylinder 20 about said fourth axis Z4 relative to the vehicle body B.

According to an aspect of the present disclosure, said tension cylinder 20 is configured to provide certain tension in the longitudinal direction of said endless track E. According to an aspect of the present disclosure, said tension cylinder 20 is configured to provide a predetermined tension in the longitudinal direction of said endless track E.

According to an aspect of the present disclosure, said tension wheel member TW with said tension wheels TW1, TW2, crankshaft 10 and tension cylinder 20 is configured to be arranged so as to provide a desired tension of said endless track E.

During operation of said tracked vehicle V involving e.g. rotation of said endless track E, certain movement of said crankshaft 10 will occur. During operation of said tracked vehicle V involving e.g. rotation of said endless track E, movement of said crankshaft 10 about one or more of said first axis Z1, second axis Z2 and third axis Z3 may occur.

During operation of said tracked vehicle V involving e.g. rotation of said endless track E, certain pressure variation of said tension cylinder 20 will occur. During operation of said tracked vehicle V involving e.g. rotation of said endless track E, pressure variation of said tension cylinder 20 in the longitudinal direction of said endless track E based on vehicle operation and set tension of said tension cylinder 20.

According to an aspect of the present disclosure, said endless track E comprises a wire configuration W arranged within said endless track E. Said wire configuration W is configured to run in the longitudinal extension of said endless track E around said endless track E. See FIG. 3. According to an aspect of the present disclosure, said wire configuration W comprises one or more wires configured to run in the longitudinal extension of said endless track E around said endless track E. According to an aspect of the present disclosure, said wire configuration W comprises one or more wires configured to run within said endless track E in the longitudinal extension of said endless track E around said endless track E. According to an aspect of the present disclosure, said wire configuration W comprises one or more wires configured to run in the longitudinal extension of said endless track E around said endless track E multiple laps. According to an aspect of the present disclosure, said wire configuration W comprising one or more wires configured to run in the longitudinal extension of said endless track E multiple laps around said endless track E are configured to be distributed along the width of said endless track E. See FIG. 3.

According to an aspect of the present disclosure, said wire configuration W may comprise one or more steel wires.

According to an aspect of the present disclosure, said wire configuration W is configured to provide connection for said endless track E. According to an aspect of the present disclosure, said wire configuration W is configured to provide longitudinal attachment for said endless track E. According to an aspect of the present disclosure, said wire configuration W is configured to longitudinally hold said endless track E together.

According to an aspect of the present disclosure, said at least one wire of said wire configuration W may be configured to run in the longitudinal extension of said endless track E around said endless track E laps in the range of 20-100, i.e. running around said endless track in the longitudinal extension 20 to 100 times.

According to an aspect of the present disclosure, said tracked vehicle V is provided with at least one sensor 30. According to an aspect of the present disclosure, said at least one sensor 30 is configured to provide measurement information associated with vibrations of said endless track E.

According to an aspect of the present disclosure, said at least one sensor 30 is configured to be arranged in connection to said track assembly T1. According to an aspect of the present disclosure, said at least one sensor 30 is configured to be arranged in connection to said tension wheel member TW of said track assembly.

According to an aspect of the present disclosure, said at least one sensor 30 is configured to measure movement of crankshaft 10 of tension wheel member TW. According to an aspect of the present disclosure, said at least one sensor 30 comprises at least one accelerometer 32.

According to an aspect of the present disclosure, said at least one sensor 30 is configured to measure pressure variation of tension cylinder 20 of tension wheel member TW. According to an aspect of the present disclosure, said at least one sensor 30 comprises at least one pressure sensor 34.

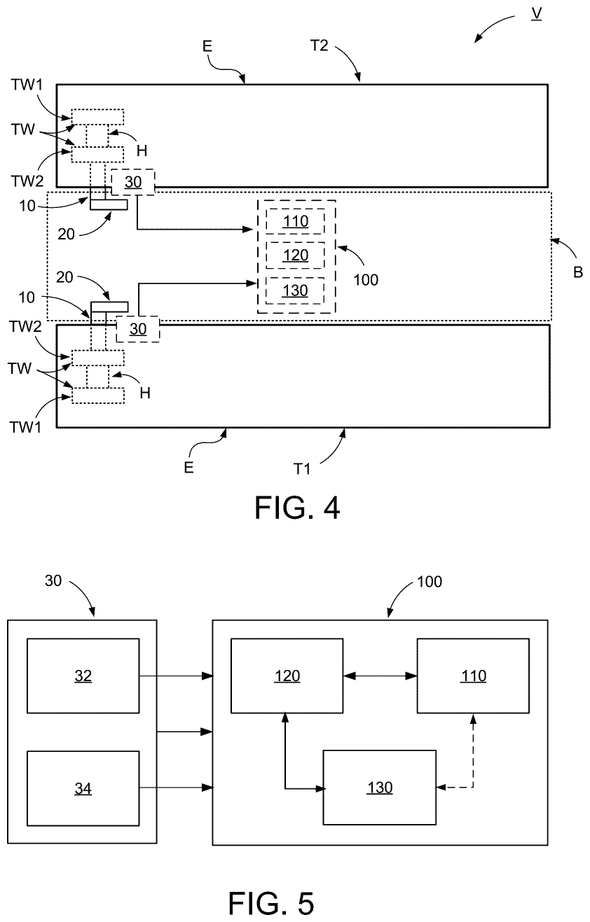

FIG. 4 schematically illustrates a plan view of a tracked vehicle V according to an embodiment of the present disclosure. The tracked vehicle V may be a tracked vehicle according to FIG. 1.

The tracked vehicle V comprises a right track assembly T1 and a left track assembly T2. The track assemblies may correspond to the left track assembly shown in FIGS. 1 and 2 and partly in FIG. 3. Each track assembly T1, T2 comprises a drive wheel member, not shown in FIG. 4, a tension wheel member TW, a set of road wheels, not shown in FIG. 4, and an endless track E arranged to run over said wheels.

According to an aspect of the present disclosure, as exemplified in FIG. 3, and schematically illustrated in FIG. 4, the respective tension wheel member TW comprises a hub member H, an outer tension wheel TW1 arranged in connection to an outer side of said hub member H and an inner tension wheel TW2 arranged in connection to an inner side of said hub member H.

According to an aspect of the present disclosure, as exemplified in FIG. 3, and schematically illustrated in FIG. 4, the respective tension wheel member TW comprises a crankshaft 10, arranged in connection to said inner tension wheel TW1.

According to an aspect of the present disclosure, as exemplified in FIG. 3, and schematically illustrated in FIG. 4, the respective tension wheel member TW comprises or is operably connected to a tension cylinder 20, connected to said crankshaft 10.

According to an aspect of the present disclosure, as exemplified in FIG. 3, and schematically illustrated in FIG. 4, the tracked vehicle V, i.e. the respective track assembly T1, T2 of the tracked vehicle V, comprises at least one sensor 30 configured to provide measurement information associated with vibrations of said endless track E. According to an aspect of the present disclosure, said at least one sensor 30 is configured to be arranged in connection to said tension wheel member TW of the respective track assembly T1, T2.

According to an aspect of the present disclosure, schematically illustrated in FIG. 4, the tracked vehicle V comprises at least one processor 110 operatively connected to said at least one sensor 30. Said at least one processor 110 is configured to receive, from said at least one sensor 30, measurement information associated with vibrations of said endless track. Said at least one processor 110 is configured to, based on the information received from said at least one sensor 30, determine if there is a natural frequency of said endless track E and if so determine the natural frequency of said endless track E. Said at least one processor 110 is configured to, based on the determination associated with natural frequency, determine whether or not there is a potential damage to the endless track E.

According to an aspect of the present disclosure, said at least one sensor 30 and said at least one processor 110 provides a device for determining potential damage of an endless track E of a tracked vehicle V.

According to an aspect of the present disclosure, schematically illustrated in FIG. 4, and FIG. 5, said at least one processor 110 is configured to be comprised in a control device 100 for determining potential damage of an endless track E of a tracked vehicle. Thus, FIG. 5 schematically illustrates a block diagram of a control device 100 for determining potential damage of an endless track E of a tracked vehicle according to an embodiment of the present disclosure. As schematically illustrated in FIG. 4 the control device may be arranged in connection to the vehicle body B of the tracked vehicle. According to an aspect of the present disclosure such a control device 100 may comprise one or more control units. According to an aspect of the present disclosure such a control device 100 may comprise one or more control units arranged in connection to the respective track assembly T1, T2. According to an aspect of the present disclosure such a control device 100 may comprise at least one of said at least one sensors. According to an aspect of the present disclosure, said at least one sensor 30 may be comprised in said control device 100.

According to an aspect of the present disclosure, at least one of said at least one processor 110 may, for the respective track assembly T1, T2, be arranged in connection to the at least one sensor 30 in a sensor module or the like.

According to an aspect of the present disclosure, schematically illustrated in FIG. 4, and FIG. 5, the tracked vehicle V comprises said control device 100 operatively connected to said at least one sensor 30. Said at control device 100 is configured to receive, from said at least one sensor 30, measurement information associated with vibrations of said endless track E. Said control device 100 is configured to, based on the information received from said at least one sensor 30, determine if there is a natural frequency of said endless track E and if so determine the natural frequency of said endless track E. Said control device 100 is configured to, based on the determination associated with natural frequency, determine whether or not there is a potential damage to the endless track E.

According to an aspect of the present disclosure, said at least one sensor 30 and said control device 100 comprising said at least one processor 110 provides a device for determining potential damage of an endless track E of a tracked vehicle V.

According to an aspect of the present disclosure, the control device 100 comprises a memory arrangement 120. The memory arrangement 120 may comprise at least one memory. The control device 100 thus comprises at least one memory.

According to an aspect of the present disclosure, the control device 100 comprises a communication interface 130. The communication interface 130 may also be denoted communication unit.

According to an aspect of the present disclosure, the at least one processor 110 of the control device 100 is operably connectable to said at least one sensor 30. According to an aspect of the present disclosure, the at least one sensor 30 may be comprised in and/or operably connected to said control device 100. According to an aspect of the present disclosure, the at least one sensor 30 may be operably connected to said control device 100 via a link.

According to an aspect of the present disclosure, the memory arrangement 120 of the control device 100 may be integrated with or embedded into the at least one processor 110, and/or be a separate memory hardware device. According to an aspect of the present disclosure, the memory arrangement 120 of the control device 100 is operably connectable to the at least one processor 110. According to an aspect of the present disclosure, at least one of the at least one memory of the memory arrangement 120 may be integrated with or embedded into the at least one processor 110, and/or be a separate memory hardware device.

The memory arrangement 120 may include a RAM, a ROM, a hard disk, an optical disk, a magnetic medium, a flash memory and/or any other mechanism capable of storing instructions or data.

According to an aspect of the present disclosure, the at least one processor 110 of the control device 100 may include any physical device having an electric circuit that performs logic operations on input data. According to an aspect of the present disclosure, the at least one processor 110 of the control device 100 may include any physical device having an electric circuit that performs logic operations on input data. For example, the at least one processor 110 may include one or more integrated circuits, microchips, microcontrollers, microprocessors, all or part of a CPU, DSP, FPGA, or other circuits for executing instructions or performing logic operations. According to an aspect of the present disclosure, actions and method steps described herein as being performed by the control device 100 are performed by the at least one processor 110 of the control device 100 upon execution of one or more computer programs stored in the memory arrangement 120. According to an aspect of the present disclosure, actions and method steps described herein as being performed by the at least one processor 110 are performed by the at least one processor 110 of the control device 100 upon execution of one or more computer programs stored in the memory arrangement 120.

According to an aspect of the present disclosure, the communication interface 130 is operably connected to said memory arrangement 120. According to an aspect of the present disclosure, the communication interface 130 may be operably connected to said the at least one processor 110.

Said at least one sensor 30 is configured to obtain measurement information associated with vibrations of said endless track E. Said at least one sensor 30 may be any suitable kind of sensor. According to an aspect of the present disclosure, said at least one sensor 30 is configured to detect vibrations of said endless track E. Said at least one sensor 30 is configured to send measurement information associated with vibrations of said endless track E to said at least one processor 110. According to an aspect of the present disclosure, the at least one sensor 30 is configured to send one or more signals associated with vibrations of said endless track E to said at least one processor 110.

Said at least one sensor 30 may comprise at least one sensor 32 for detecting movement of crankshaft 10 of tensions wheel member TW of track assembly T1, T2 of tracked vehicle V. Said at least one sensor 32 for detecting movement of crankshaft 10 of tensions wheel member TW is according to an aspect operably connected to said at least one processor 110. Said at least one sensor 32 for detecting movement of crankshaft 10 of tensions wheel member TW may comprise an accelerometer arranged in connection to said crankshaft 10.

Said at least one sensor 30 may comprise at least one sensor 34 for detecting pressure variation of a tension cylinder 20 in connection to said tension wheel member TW of said track assembly T1, T2 of said tracked vehicle V. Said at least one sensor 34 for detecting pressure variation of a tension cylinder 20 is according to an aspect operably connected to said at least one processor 110. Said at least one sensor 34 for detecting pressure variation of a tension cylinder 20 may comprise a pressure sensor arranged in connection to said tension cylinder 20.

Said at least one processor 110 is configured to receive measurement information associated with vibrations of said endless track E. Said at least one processor 110 is configured to receive one or more signals via one or more links comprising information associated with vibrations of said endless track E. Said at least one processor 110 is configured to, based on the information received from said at least one sensor 30, determine if there is a natural frequency of said endless track E and if so determine the natural frequency of said endless track E. Said at least one processor 110 is configured to processes said measurement information associated with vibrations of said endless track E so as to determine possible natural frequency of said endless track E. Based on the determination associated with natural frequency, said at least one processor 110 is configured to determine whether or not there is a potential damage to the endless track E.

According to an aspect of the present disclosure, the control device 100 may, if a potential damage to the endless track is determined, be configured to take action based on said determined potential damage to the endless track. Such an action may be any suitable action. Such an action may be informing an operator of the tracked vehicle and/or a control centre or the like, of the thus determined potential damage to the endless track. According to an aspect of the present disclosure, if a potential damage to the endless track is determined to be not likely, be configured to take action based on said determined unlikely potential of damage to the endless track. Such an action may be any suitable action. Such an action may be informing an operator of the tracked vehicle and/or a control centre or the like, of that said tracked vehicle is operable. Such action configured to be taken by said control device 100 may comprise sending information to an operator/client to a mobile application (app) configured to be run on a mobile electronic device, such as a mobile phone or a tablet computer, or in form of a desktop application configured to be run on a laptop or desktop computer. Such a mobile electronic device may be operably connected to said control device 100. Such a mobile electronic device may be comprised in said control device 100. Such a mobile electronic device may be operably connected to said at least one processor. Such a mobile electronic device may be operably connected to said at least one sensor.

Said at least one processor 110 is configured to determine if there is a natural frequency of said endless track E, and if so, determining the natural frequency in the longitudinal extension of said endless track E based on the information received from said at least one sensor 30. Said endless track E comprises said wire configuration W, see FIG. 3, arranged within said endless track E and configured to run in the longitudinal extension of said endless track E around said endless track E. According to an aspect of the present disclosure, said wire configuration W provides and/or contributes to the stiffness of said endless track, wherein a broken wire/wire portion of said wire configuration may change the stiffness of said endless track such that natural frequency in the longitudinal extension of said endless track E based on the information received from said at least one sensor 30 is facilitated. Said wire configuration W may according to an aspect of the present disclosure be a wire configured to run within said endless track a number of laps within and around said endless track such that a number of wire portions are running within said endless track adjacent to each other so as to provide an increased stiffness of said endless track. Alternatively said wire configuration W, according to an aspect of the present disclosure may comprise a set of individual wires arranged to run one or more laps within said endless track and be arranged adjacent to each other. Broken/torn apart wire/wire portions changes the stiffness in the longitudinal direction and hence the natural frequency of said endless track. According to an aspect of the present disclosure, said at least one processor 110 is configured to determine if there is a natural frequency of said endless track, and if so, determining the natural frequency in the longitudinal extension of said endless track E based on the information received from said at least one sensor 30 so as to determined possible broken/torn apart wire/wire portions of said wire configuration W.

Said wire configuration provides and/or contributes to the stiffness of said endless track in the longitudinal direction, wherein a broken wire/wire portion of said wire configuration may change the stiffness of said endless track in the longitudinal direction. The natural frequency of said endless track is thus associated with said wire configuration providing/contributing to the stiffness of said endless track. Should said wire configuration be broken such that one or more wires or portions of the wire at one or more laps are broken, there will be a reduction of said natural frequency compared to a none-broken state of said wire configuration.

Said at least one processor 110, when determining, based on the determination associated with natural frequency, whether or not there is a potential damage to the endless track, may be configured to determine whether or not there is a damage to said wire configuration. According to an aspect of the present disclosure, said at least one processor 110, when determining, based on the determination associated with natural frequency, whether or not there is a potential damage to the endless track, may be configured to determine whether or not there is a damage to said wire configuration and the extent to which said wire configuration is damaged. Hereby the degree of damage to the endless track may be determined so as to facilitate determining whether or not the tracked vehicle should be driven. Hereby the degree of damage to the wire configuration and hence the endless track may be determined so as to facilitate determining whether or not the tracked vehicle should be driven based on estimated number of wire portions/wires of said wire configuration being broken.

According to an aspect of the present disclosure, said at least one processor 110, when determining whether or not there is a potential damage to the endless track E, is configured to compare the determination associated with natural frequency of said endless track E with a predetermined natural frequency associated with said endless track E. According to an aspect of the present disclosure, said at least one processor 110, when determining whether or not there is a potential damage to the endless track E, is configured determine a potential damage to the endless track E if the difference between said determination associated with natural frequency and said predetermined natural frequency exceeds a predetermined threshold.

According to an aspect of the present disclosure, said at least one processor 110, when receiving, from said at least one sensor 30, measurement information associated with vibrations of said endless track E, is configured to receive information from measurement of movement of said crankshaft 10 of said tension wheel member TW. According to an aspect of the present disclosure, said at least one processor 110, is configured to receive information from measurement of movement of said crankshaft 10 from said at least one sensor 32, e.g. accelerometer, for detecting movement of crankshaft 10 of tension wheel member TW of track assembly T1, T2 of tracked vehicle V. According to an aspect of the present disclosure, said at least one processor 110 is configured to determine if there is a natural frequency of said endless track, and if so, determining the natural frequency based on said received information about crankshaft movement.

According to an aspect of the present disclosure, said at least one processor 110, when receiving, from said at least one sensor 30, measurement information associated with vibrations of said endless track E, is configured to receive information from measurement of pressure variation of said tension cylinder 20 of said tension wheel member TW of said track assembly T1, T2. According to an aspect of the present disclosure, said at least one processor 110, is configured to receive information from measurement of pressure variation of said tension cylinder 20 from said at least one sensor 34, e.g. pressure sensor, for detecting pressure variation of said tension cylinder 20. According to an aspect of the present disclosure, said at least one processor 110 is configured to determine if there is a natural frequency of said endless track, and if so, determining the natural frequency based on said received information about pressure variation.

According to an aspect of the present disclosure, said at least one processor 110, when receiving, from said at least one sensor 30, measurement information associated with vibrations of said endless track E, is configured to receive measurement information from measurements performed during a drive sweep of said tracked vehicle V, said drive sweep comprising driving said vehicle V at a lower speed followed by a higher speed followed by said lower speed. Thus, said drive sweep comprises driving said vehicle at a lower speed of said tracked vehicle followed by a higher speed, where said higher speed is higher than said lower speed, wherein said higher speed is then followed by said lower speed. Said lower speed may be any suitable lower speed. Said higher speed may be any suitable higher speed. Said lower speed and higher speed may depend on configuration of track and/or configuration of track assembly, and/or configuration of tracked vehicle. Configuration of track may comprise size of track and/or weight of track and/or type of track. Configuration of track assembly may comprise size of track assembly and/or weight of track assembly and/or type of track assembly. Configuration of track may comprise size of track and/or weight of track and/or type of track. Configuration of tracked vehicle may comprise size of tracked vehicle and/or weight of tracked vehicle and/or type of tracked vehicle. According to an aspect of the present disclosure, said lower speed may be in the range from 10 km/h to 20 km/h, and said higher speed may be about 20 km/h to 30 km/h, where said higher speed is higher than said lower speed. According to an aspect of the present disclosure, said lower speed may be about 15 km/h and said higher speed may be about 25 km/h. According to an aspect of the present disclosure, said difference between said lower speed and said higher speed may be about 8 to 12 km/h, said higher speed being higher than said lower speed. Said lower speed and higher speed are speeds within in a ranged where natural frequency may be determined by means of measurements performed during such a drive sweep.

According to an aspect of the present disclosure, said at least one processor 110, when receiving measurement information from measurements performed during said drive sweep, is configured to receive measurement information from measurements performed during said sweep performed on predetermined solid ground having a relatively hard and even surface configured to support said tracked vehicle V. According to an aspect of the present disclosure, said at least one processor 110, when receiving measurement information from measurements performed during said drive sweep, is configured to receive measurement information from measurements performed during said sweep performed on predetermined solid ground having an even surface configured to support said tracked vehicle V.

Said solid ground with even surface is such that the movement of the vehicle is such that measurements performed during such a drive sweep is not interfered by undesired movement of the vehicle. Said solid ground with even surface is such that the movement of the vehicle is such that measurements associated with determination of natural frequency performed during such a drive sweep is not interfered by undesired movement of the vehicle due to the natural frequency being extinguished caused by such undesired movement.

Solid ground refers to a ground configured to fully support the tracked vehicle, e.g. asphalt, concreate or the like, so that the vehicle, during drive on said solid ground, is essentially not subjected to any disturbances in its movement in the intended drive direction. Such disturbances in the movement of the tracked vehicle during drive of the vehicle may refer to movements in a direction essentially orthogonal to the longitudinal and transversal extension of the vehicle, caused e.g. by bumps, oscillations or the like. Even surface refers to a surface not having any substantial unevenness such as bumps, cavities or the like, so that the vehicle, during drive on said solid ground, is essentially not subjected to any disturbances in its movement in the intended drive direction. Such disturbances in the movement of the tracked vehicle during drive of the vehicle may refer to movements in a direction essentially orthogonal to the longitudinal and transversal extension of the vehicle, caused e.g. by bumps, oscillations or the like.

The predetermined solid ground may e.g. be asphalt, concrete or the like. The predetermined solid ground is according to an aspect essentially horizontal. According to an aspect of the present disclosure, said at least one processor 110, when receiving measurement information from measurements performed during said drive sweep, may be configured to receive measurement information from measurements performed during said sweep performed on soft ground which may be an even surface being essentially horizontal or having a certain slope, such as a certain downhill slope.

According to an aspect of the present disclosure, said at least one processor 110, when receiving, from said at least one sensor 30, measurement information associated with vibrations of said endless track E, is configured to receive measurement information from measurements performed during a first standstill position of said tracked vehicle V. According to an aspect of the present disclosure, an external trigger frequency is applied in connection to said track assembly T1, T2 during said first standstill position. According to an aspect of the present disclosure, said at least one processor 110 is, during said first standstill position of said tracked vehicle, configured to receive an external trigger frequency. Said first standstill position refers to a standstill position of the tracked vehicle where a first portion of said endless track is engaged with the ground. Said first standstill position refers to a standstill position of the tracked vehicle where a first portion of said endless track, comprising portions of a wire configuration configured to run in the longitudinal extension of said endless track around said endless track, is engaged with the ground.

According to an aspect of the present disclosure, where said endless track comprises a wire configuration W, should one or more wires/wire portions of the wire configuration W of the endless track not being engaged with the ground in said first standstill be broken, a lower natural frequency would be received from said at least one sensor 30 by said at least one processor 110 when said external trigger frequency is applied in connection to said track assembly, so that, when receiving measurement information from measurements performed during said first standstill position of said tracked vehicle, a potential damage to said endless track may be determined.

According to an aspect of the present disclosure, in a first variant, said external trigger frequency is configured to be applied in connection to said track assembly by means of pulsating hydraulic pressure in said tension cylinder 20. According to an aspect of the present disclosure, said pulsation of hydraulic pressure is configured to be provided within a predetermined frequency sweep from a relatively lower frequency to a relatively higher frequency and back to said relatively lower frequency. Thus, said pulsation of hydraulic pressure is within a predetermined frequency sweep from a relatively lower frequency to a relatively higher frequency, where said higher frequency is higher than said lower frequency, and back to said relatively lower frequency. Said predetermined frequency sweep may be any suitable frequency sweep. According to an aspect of the present disclosure, said lower frequency may be in the range from 30 Hz to 50 Hz, and said higher frequency may be about 50 Hz to 70 Hz, where said higher frequency is higher than said lower frequency. According to an aspect of the present disclosure, said relatively lower frequency may be about 40 Hz and said relatively higher frequency may be about 60 Hz. According to an aspect of the present disclosure, said difference between said lower frequency and said higher frequency may be about 10 to 30 Hz, said higher frequency being higher than said lower frequency. Said lower frequency and higher frequency are frequencies within in a range where natural frequency may be determined by means of measurements performed during application of said external trigger frequency.

According to an aspect of the present disclosure, in a second variant, said external trigger frequency is configured to be applied in connection to said track assembly T1, T2 by means of generating oscillations by means of a mechanical device MD applied on said tension wheel member TW. Said mechanical device MD is only schematically illustrated in FIG. 3 and its shape and its location in connection to said tension wheel member TW is not correctly illustrated. Said mechanical device may be any suitable mechanical device such as an excenter device arranged to rotate, or a weight member arranged at one side of a rotating shaft. According to an aspect of the present disclosure, said generated oscillations are configured to be within a predetermined frequency sweep from a relatively lower frequency to a relatively higher frequency and back to said relatively lower frequency. Thus, said generated oscillations are configured to be within a predetermined frequency sweep from a relatively lower frequency to a relatively higher frequency, where said higher frequency is higher than said lower frequency, and back to said relatively lower frequency. Said predetermined frequency sweep may be any suitable frequency sweep. According to an aspect of the present disclosure, said lower frequency may be in the range from 30 Hz to 50 Hz, and said higher frequency may be about 50 Hz to 70 Hz, where said higher frequency is higher than said lower frequency. According to an aspect of the present disclosure, said relatively lower frequency may be about 40 Hz and said relatively higher frequency may be about 60 Hz. According to an aspect of the present disclosure, said lower frequency may be in the range from 30 Hz to 50 Hz, and said higher frequency may be about 50 Hz to 70 Hz, where said higher frequency is higher than said lower frequency. Said lower frequency and higher frequency are frequencies within in a range where natural frequency may be determined by means of measurements performed during application of said external trigger frequency.

According to an aspect of the present disclosure, said at least one processor 110, when receiving, from said at least one sensor 30, measurement information associated with vibrations of said endless track E, is configured to receive measurement information from measurements performed during a second standstill position, which follows said first standstill position. According to an aspect of the present disclosure, said tracked vehicle is configured to be moved from said first standstill position to said second standstill position such that the endless track E has been rotated so that the portion of the endless track E engaged with the ground during said first standstill has been moved so that it, in said second standstill position, is no longer engaged with the ground of said tracked vehicle, during which second standstill said external trigger frequency is applied in connection to said track assembly T1, T2. Said second standstill position refers to a standstill position of the tracked vehicle where a second portion of said endless track, different from said first portion of said endless track, is engaged with the ground. Said second standstill position refers to a standstill position of the tracked vehicle where a second portion of said endless track, comprising portions of a wire configuration configured to run in the longitudinal extension of said endless track around said endless track, is engaged with the ground.

According to an aspect of the present disclosure, where said endless track comprises a wire configuration, should one or more wires/wire portions of the wire configuration of the endless track being engaged with the ground in said first standstill be broken, a lower natural frequency would be expected when an external trigger frequency is applied in connection to said track assembly, when said tracked vehicle has been moved to said second standstill position, when said at least one processor 110 is receiving measurement information from measurements performed during said second standstill position of said tracked vehicle, wherein a potential damage to said endless track may be determined. Thus, a difference between the natural frequency thus detected by applying such external trigger frequency in a first standstill and in a second standstill may indicate potential damage to said endless track, and also which portion of said endless track.

If said external trigger frequency applied in connection to said track assembly T1, T2 was based on said first variant, i.e. pulsating hydraulic pressure in said tension cylinder 20 during a frequency sweep, during the first standstill position, the first variant will be applied also during the second standstill position. If said external trigger frequency applied in connection to said track assembly T1, T2 was based on said second variant, i.e. rating oscillations by means of a mechanical device applied on said tension wheel member TW during a frequency sweep, during the first standstill position, the second variant will be applied also during the second standstill position.

Thus, according to an aspect of the present disclosure, said at least one processor 110, when receiving measurement information from measurements performed during said first and second standstills, is configured to receive said information when said external trigger frequency is configured to be applied in connection to said track assembly by means of said first variant, i.e. pulsating hydraulic pressure in a tension cylinder 20 in connection to said tension wheel member TW of said track assembly T1, T2, where said pulsation of hydraulic pressure has been within a predetermined frequency sweep from a relatively lower frequency to a relatively higher frequency, higher than said lower frequency, and back to said relatively lower frequency.

Thus, according to an aspect of the present disclosure, said at least one processor 110, when receiving measurement information from measurements performed during said first and second standstills, is configured to receive said information when said external trigger frequency is configured to be applied in connection to said track assembly T1, T2 by means of said second variant, i.e. generating oscillations by means of a mechanical device applied on said tension wheel member, where said generated oscillations have been within a predetermined frequency sweep from a relatively lower frequency to a relatively higher frequency higher than said lower frequency and back to said relatively lower frequency.

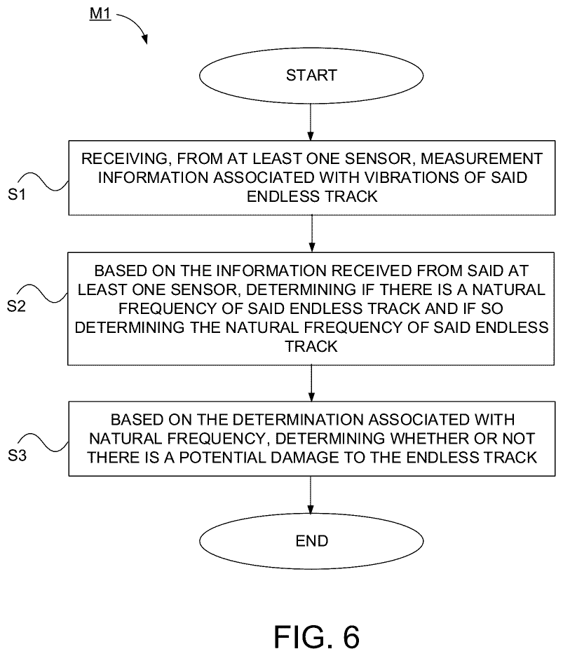

The tracked vehicle V is, according to an embodiment, arranged to be operated in accordance with a method M1 for determining potential damage of an endless track of a tracked vehicle according to FIG. 6.

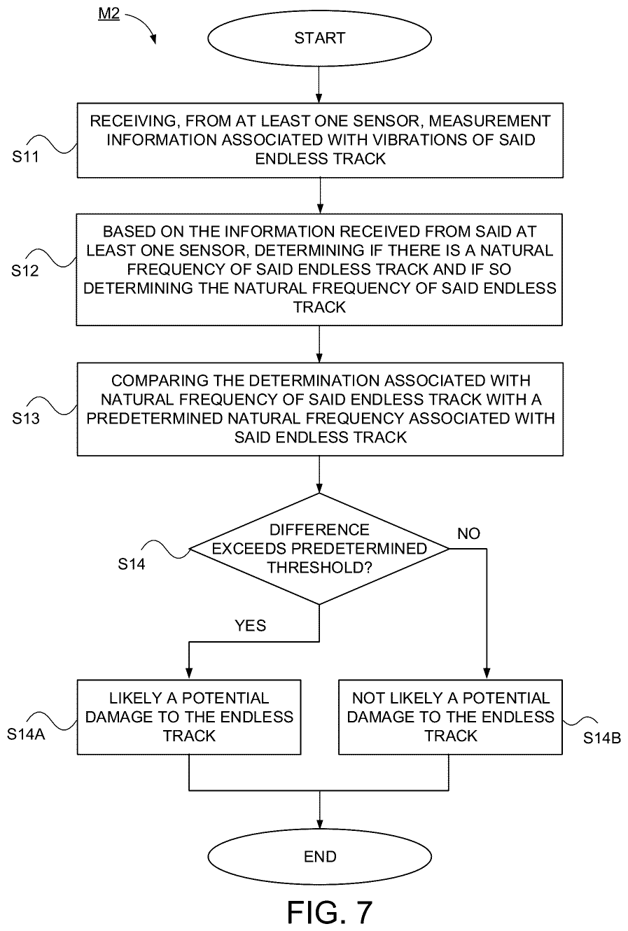

The tracked vehicle V is, according to an embodiment, arranged to be operated in accordance with a method M2 for determining potential damage of an endless track of a tracked vehicle according to FIG. 7.

FIG. 6 schematically illustrates a flow chart of a method M1 for determining potential damage of an endless track of a tracked vehicle according to an aspect of the present disclosure.

Said tracked vehicle comprises at least one track assembly comprising a drive wheel member, a tension wheel member, a set of road wheels and said endless track disposed in its longitudinal extension around said wheels. Said endless track is configured to be rotated by means of said drive wheel member during drive of the tracked vehicle. According to an aspect of the present disclosure, said endless track comprises a wire configuration arranged within said endless track and configured to run in the longitudinal extension of said endless track around said endless track. The tracked vehicle may be any suitable tracked vehicle. The tracked vehicle may be a tracked vehicle according to FIGS. 1 and 4. The tracked vehicle may comprise a track assembly according to claim 1-4.

According to the aspect the method M1 comprises a step S1. In this step, measurement information associated with vibrations of said endless track is received from at least one sensor.

According to the aspect the method M1 comprises a step S2. In this step, it is determined, based on the information received from said at least one sensor, if there is a natural frequency of said endless track and if so, the natural frequency of said endless track is determined. The step S2 of determining if there is a natural frequency of said endless track and if so, the natural frequency of said endless track, comprises, according to an aspect of the present disclosure, determining if there is a natural frequency in the longitudinal extension of said endless track and if so, determining the natural frequency in the longitudinal extension of said endless track. The step S2 thus, according to an aspect of the present disclosure, comprises determining the longitudinal natural frequency of said endless track, if there is a longitudinal frequency, and if not, step S2 comprises determining that there is no longitudinal natural frequency. The step of determining that there is no longitudinal natural frequency refers to determining that no longitudinal natural frequency has been detected by means of said at least one sensor.

According to the aspect the method M1 comprises a step S3. In this step, it is determined, based on the determination associated with natural frequency, whether or not there is a potential damage to the endless track. If, in step S2, a natural frequency of said endless track is determined, based on the information received from said at least one sensor, it is, in step S3, determined whether or not there is a potential damage to the endless track based on the thus determined natural frequency. According to an aspect of the present disclosure, the thus determined natural frequency is associated with said wire configuration running in the longitudinal direction within and around said endless track. According to an aspect of the present disclosure, a determined potential damage to the endless track based on the determined natural frequency is associated with said wire configuration running in the longitudinal direction within and around said endless track, where a damage to one or more wires/wire portions of said wire configuration affects, i.e. reduces, expected natural frequency of said endless track. If it, in step S2, is determined that there is no natural frequency of said endless track, based on the information received from said at least one sensor, it is, in step S3, determined whether or not there is a potential damage to the endless track based on the thus determined lack of natural frequency of said endless track. The step of determining that there is no natural frequency refers to determining that no natural frequency has been detected by means of said at least one sensor.

According to an aspect of the present disclosure, the method M1 may, if a potential damage to the endless track is determined, comprise a step, not shown, in which action is taken based on said determined potential damage to the endless track. Such an action may be any suitable action. Such an action may be informing an operator of the tracked vehicle and/or a control centre or the like, of the thus determined potential damage to the endless track. According to an aspect of the present disclosure, the method M1 may, if a potential damage to the endless track is determined to be not likely, comprise a step, not shown, in which action is taken based on said determined unlikely potential of damage to the endless track. Such an action may be any suitable action. Such an action may be informing an operator of the tracked vehicle and/or a control centre or the like, of that said tracked vehicle is operable.

The method M1 for determining potential damage of an endless track of a tracked vehicle is according to an embodiment adapted to be performed by the device described above with reference to FIGS. 4 and 5.

The method M1 performed by a control device for controlling driving operation of a tracked vehicle is according to an embodiment adapted to be performed by the at least one processor 110 described above with reference to FIGS. 4 and 5.

The method M1 for determining potential damage of an endless track of a tracked vehicle is according to an embodiment adapted to be performed by a computer program comprising computer-readable instructions which, when executed by at least one processor of a device for determining potential damage of an endless track of a tracked vehicle, causes the at least one processor to perform said method M1.

FIG. 7 schematically illustrates a flow chart of a method M2 for determining potential damage of an endless track of a tracked vehicle according to an aspect of the present disclosure.

Said tracked vehicle comprises at least one track assembly comprising a drive wheel member, a tension wheel member, a set of road wheels and said endless track disposed in its longitudinal extension around said wheels. Said endless track is configured to be rotated by means of said drive wheel member during drive of the tracked vehicle. According to an aspect of the present disclosure, said endless track comprises a wire configuration arranged within said endless track and configured to run in the longitudinal extension of said endless track around said endless track. The tracked vehicle may be a tracked vehicle according to FIGS. 1 and 4. The tracked vehicle may comprise a track assembly according to claim 1-4.

According to the aspect the method M2 comprises a step S11. In this step, measurement information associated with vibrations of said endless track is received from at least one sensor.

According to the aspect the method M2 comprises a step S12. In this step, it is determined, based on the information received from said at least one sensor, if there is a natural frequency of said endless track and if so, the natural frequency of said endless track is determined. The step S2 of determining if there is a natural frequency of said endless track and if so, the natural frequency of said endless track, comprises, according to an aspect of the present disclosure, determining if there is a natural frequency in the longitudinal extension of said endless track and if so, determining the natural frequency in the longitudinal extension of said endless track. The step S2 thus, according to an aspect of the present disclosure, comprises determining the longitudinal natural frequency of said endless track, if there is a longitudinal frequency, and if not, step S2 comprises determining that there is no longitudinal natural frequency.

According to the aspect the method M2 comprises a step S13. In this step, the determination associated with natural frequency of said endless track is compared with a predetermined natural frequency associated with said endless track. Said predetermined natural frequency may be determined in any suitable way. Said predetermined natural frequency may be determined for an endless track of the same type for the same kind of vehicle, which endless track is non-damaged. According to an aspect of the present disclosure the method M2 for determining the predetermined natural frequency may be the same method M2 as said method M2 for determining if there is a natural frequency of said endless track and if so determining the natural frequency of said endless track. Said predetermined natural frequency may be stored information, stored in any suitable storage device/memory.

According to the aspect the method M2 comprises a step S14. In this step, it is determined, based on said comparison, whether there is a difference, and if so, if said difference between said determination associated with natural frequency, e.g. a determined natural frequency or a lack of natural frequency of said endless track, and said predetermined natural frequency exceeds a predetermined threshold.

According to the aspect the method M2 comprises a step S14A. In this step, if said difference exceeds said predetermined threshold, a potential damage to the endless track is determined.

According to an aspect of the present disclosure, the thus determined natural frequency is associated with said wire configuration running in the longitudinal direction within and around said endless track. According to an aspect of the present disclosure, a determined potential damage to the endless track based on the determined natural frequency is associated with said wire configuration running in the longitudinal direction within and around said endless track, where a damage to one or more wires/wire portions of said wire configuration affects, i.e. reduces, said predetermined natural frequency of said endless track.

According to an aspect of the present disclosure, the method M2 may, if a potential damage to the endless track is determined, comprise a step, not shown, in which action is taken based on said determined potential damage to the endless track. Such an action may be any suitable action. Such an action may be informing an operator of the tracked vehicle and/or a control centre or the like, of the thus determined potential damage to the endless track.

According to the aspect the method M2 comprises a step S14B. In this step, if said difference does not exceed said predetermined threshold, it is determined that a potential damage to the endless track is not likely.

According to an aspect of the present disclosure, the method M2 may, if a potential damage to the endless track is determined to be not likely, comprise a step, not shown, in which action is taken based on said determined unlikely potential of damage to the endless track. Such an action may be any suitable action. Such an action may be informing an operator of the tracked vehicle and/or a control centre or the like, of that said tracked vehicle is operable.

The method M2 for determining potential damage of an endless track of a tracked vehicle is according to an embodiment adapted to be performed by the device described above with reference to FIGS. 4 and 5.

The method M2 performed by a control device for controlling driving operation of a tracked vehicle is according to an embodiment adapted to be performed by the at least one processor 110 described above with reference to FIGS. 4 and 5.

The method M2 for determining potential damage of an endless track of a tracked vehicle is according to an embodiment adapted to be performed by a computer program comprising computer-readable instructions which, when executed by at least one processor of a device for determining potential damage of an endless track of a tracked vehicle, causes the at least one processor to perform said method M2.

For the above mentioned methods M1, M2, the measurement information associated with vibrations of said endless track received from at least one sensor, may, according to aspects of the present disclosure, be obtained in any suitable way by means of any suitable sensor/sensors. Below, some aspects and/or embodiments of the present disclosure with regard to said measurement information associated with vibrations of said endless track received from at least one sensor, applicable to said methods M1, M2, are disclosed.

For the above mentioned methods M1, M2, determining if there is a natural frequency of said endless track and if so determining the natural frequency of said endless track, based on the information received from said at least one sensor may, according to aspects of the present disclosure, be obtained in any suitable way. Below, some aspects and/or embodiments of the present disclosure with regard to determination associated with natural frequency, applicable to said methods M1, M2, are disclosed.

According to an aspect of the method M1 and/or M2, the step of receiving, from said at least one sensor, measurement information associated with vibrations of said endless track comprises receiving measurement information from measurement of movement of crankshaft of tension wheel member. According to an aspect of the present disclosure, the method comprises the step of detecting, by means of said at least one sensor, measurement information from measurement of movement of crankshaft of tension wheel member. According to an aspect of the present disclosure, said at least one sensor may comprise an accelerometer.

According to an aspect of the method M1 and/or M2, the step of determining if there is a natural frequency of said endless track, and if so, determining the natural frequency, is based on said received measurement information from measurement of movement of crankshaft of tension wheel member. According to an aspect of the present disclosure, the method comprises the step of filtering a natural frequency based on measurement information from measurement of movement of crankshaft.

According to an aspect of the method M1 and/or M2, the step of receiving, from said at least one sensor, measurement information associated with vibrations of said endless track comprises receiving measurement information from measurement of pressure variation of a tension cylinder in connection to said tension wheel member of said track assembly. According to an aspect of the present disclosure, the method comprises the step of detecting, by means of said at least one sensor, measurement information from measurement of pressure variation of a tension cylinder in connection to said tension wheel member of said track assembly. According to an aspect of the present disclosure, said at least one sensor may comprise any suitable pressure sensor.

According to an aspect of the method M1 and/or M2, the step of determining if there is a natural frequency of said endless track, and if so, determining the natural frequency, is based on said received measurement information from measurement of pressure variation of a tension cylinder in connection to said tension wheel member. According to an aspect of the present disclosure, the method comprises the step of filtering a natural frequency based on measurement information from measurement of pressure variation of a tension cylinder in connection to said tension wheel member.

According to an aspect of the method M1 and/or M2, the step of receiving, from said at least one sensor, measurement information associated with vibrations of said endless track comprises receiving measurement information from measurements performed during a drive sweep of said tracked vehicle, said drive sweep comprising driving said vehicle at a lower speed followed by a higher speed, said higher speed being higher than said lower speed, said higher speed being followed by said lower speed.

According to an aspect of said method, the step of receiving measurement information from measurements performed during a drive sweep relates to a drive sweep performed on predetermined solid ground having a relatively hard and even surface configured to support said tracked vehicle. Said solid ground with even surface is such that when the tracked vehicle is driving on such ground performing a drive sweep, measurements associated with determination of natural frequency performed during such a drive sweep is not interfered by undesired movement of the vehicle such as bumps or the like.

According to an aspect of the method M1 and/or M2, the step of receiving, from said at least one sensor, measurement information associated with vibrations of said endless track comprises receiving measurement information from measurements performed during a first standstill position of said tracked vehicle, during which first standstill position an external trigger frequency is applied in connection to said track assembly. According to an aspect of the present disclosure, said first standstill position refers to a standstill position of the tracked vehicle where a first portion of said endless track, comprising portions of a wire configuration configured to run in the longitudinal extension of said endless track around said endless track, is engaged with the ground, wherein the determined natural frequency based on thus applied trigger frequency is based on the status of the portion of the wire configuration in said endless track not being engaged with the ground. Thus, during said first standstill, one or more damaged/broken wires/wire portions in the part of the endless track not being engaged with the ground would result in measurement information indicating potential damage to the endless track.

According to an aspect of the method M1 and/or M2, the step of receiving, from said at least one sensor, measurement information associated with vibrations of said endless track comprises receiving measurement information from measurements performed during a second standstill position, which follows said first standstill position, wherein said tracked vehicle has been moved from said first standstill position to said second standstill position such that the endless track has been rotated, so that the portion of the endless track currently engaged with the ground, i.e. so that the portion of the endless track engaged with the ground during said first standstill position, is moved so that it, in said second standstill position, is no longer engaged with the ground of said tracked vehicle, during which second standstill said external trigger frequency is applied in connection to said track assembly. According to an aspect of the present disclosure, said second standstill position refers to a standstill position of the tracked vehicle where a second portion of said endless track, comprising portions of a wire configuration configured to run in the longitudinal extension of said endless track around said endless track, is engaged with the ground, wherein the determined natural frequency based on thus applied trigger frequency is based on the status of the portion of the wire configuration in said endless track not being engaged with the ground. Thus, during said second standstill, one or more damaged/broken wires/wire portions in the part of the endless track not being engaged with the ground would result in measurement information indicating potential damage to the endless track. Thus, a difference between the natural frequency thus detected by applying such external trigger frequency in a first standstill and a second standstill may indicate potential damage to said endless track and also which portion of said endless track.

According to an aspect of the method M1 and/or M2, the step of receiving measurement information from measurements performed during said first and second standstills comprises measurements performed during application of said external trigger frequency by pulsating hydraulic pressure in a tension cylinder in connection to said tension wheel member of said track assembly, said pulsation of hydraulic pressure being within a predetermined frequency sweep from a relatively lower frequency to a relatively higher frequency, said higher frequency being higher than said lower frequency, and back to said relatively lower frequency.

According to an aspect of the method M1 and/or M2, the step of receiving measurement information from measurements performed during said first and second standstills comprises measurements performed during application of said external trigger frequency by generating oscillations by means of a mechanical device applied on said tension wheel member, said generated oscillations being within a predetermined frequency sweep from a relatively lower frequency to a relatively higher frequency, said higher frequency being higher than said lower frequency, and back to said relatively lower frequency.

According to a second aspect of the present disclosure, as clear from the foregoing description, the method M1, M2 is typically a computer-implemented method performed by one or more processors of the device upon execution of a computer program. As also clear from the foregoing description, the computer program may be a distributed computer program comprising program components residing in the control device 100.

According to a second aspect of the present disclosure, the above-described method M1, M2 is typically a computer-implemented method that may be performed upon execution of a computer program by one or more processors of a device for determining potential damage of an endless track of a tracked vehicle.

Thus, according to a second aspect of the present disclosure there is provided a computer program comprising computer-readable instructions which, when executed by at least one processor of a device for determining potential damage of an endless track of a tracked vehicle, causes the at least one processor to perform the steps of:
receiving, from at least one sensor, measurement information associated with vibrations of said endless track;
based on the information received from said at least one sensor, determining if there is a natural frequency of said endless track and if so determining the natural frequency of said endless track: and,
based on the determination associated with natural frequency, determining whether or not there is a potential damage to the endless track.

The computer program may further comprise instructions for causing the at least one processor of the device to perform any of, or any combination of, the method steps of the above described method.

The computer program may comprise several computer program components or applications configured to perform different steps of the above described method. For instance, the computer program may comprise a program component or application for data analysis and data communication residing in the control device. According to an aspect, the computer program may comprise a program component or application in form of a client application for data presentation of data and interaction with a user, residing in an electronic device of the user. The client application may, for example, be realized in form of a mobile application (app) configured to be run on a mobile electronic device, such as a mobile phone or a tablet computer, or in form of a desktop application configured to be run on a laptop or desktop computer.

According to an aspect of the present disclosure there is provided a computer program product comprising at least one computer-readable medium, such as a non-volatile memory, storing the above mentioned computer program.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. A method for determining potential damage of an endless track of a tracked vehicle, said tracked vehicle comprising at least one track assembly comprising a drive wheel member, a tension wheel member, a set of road wheels and said endless track disposed in its longitudinal extension around said wheels, said endless track being configured to be rotated by means of said drive wheel member during drive of the tracked vehicle, the method comprising the steps of:
receiving, from at least one sensor, measurement information associated with vibrations of said endless track;
based on the information received from said at least one sensor, determining if there is a natural frequency of said endless track and if so determining the natural frequency of said endless track; and,
based on the determination associated with natural frequency, determining whether or not there is a potential damage to the endless track.

2. The method of claim 1, wherein the step of determining if there is a natural frequency of said endless track, and if so, determining the natural frequency of said endless track comprises determining if there is a natural frequency of said endless track, and if so, determining the natural frequency in the longitudinal extension of said endless track.

3. The method of claim 1, wherein said endless track comprises a wire configuration arranged within said endless track and configured to run in the longitudinal extension of said endless track around said endless track.

4. The method of claim 1, wherein the step of determining whether or not there is a potential damage to the endless track comprises the steps of:
comparing the determination associated with natural frequency of said endless track with a predetermined natural frequency associated with said endless track; and,
determining a potential damage to the endless track if the difference between said determination associated with natural frequency and said predetermined natural frequency exceeds a predetermined threshold.

5. The method of claim 1, wherein the step of receiving, from said at least one sensor, measurement information associated with vibrations of said endless track comprises receiving measurement information from measurement of movement of crankshaft of tension wheel member, and based on said crankshaft movement determining if there is a natural frequency of said endless track, and if so, determining the natural frequency.

6. The method of claim 1, wherein the step of receiving, from said at least one sensor, measurement information associated with vibrations of said endless track comprises receiving measurement information from measurement of pressure variation of a tension cylinder in connection to said tension wheel member of said track assembly, and based on said pressure variation determining if there is a natural frequency of said endless track, and if so, determining the natural frequency.

7. The method of claim 1, wherein the step of receiving, from said at least one sensor, measurement information associated with vibrations of said endless track comprises receiving measurement information from measurements performed during a drive sweep of said tracked vehicle, said drive sweep comprising driving said vehicle at a lower speed of said tracked vehicle followed by a higher speed, said higher speed being higher than said lower speed, said higher speed being followed by said lower speed.

8. The method of claim 7, wherein the step of receiving measurement information from measurements performed during a drive sweep relates to a drive sweep performed on predetermined solid ground having an even surface configured to support said tracked vehicle.

9. The method of claim 1, wherein the step of receiving, from said at least one sensor, measurement information associated with vibrations of said endless track comprises receiving measurement information from measurements performed during a first standstill position of said tracked vehicle, during which first standstill position an external trigger frequency is applied in connection to said track assembly.

10. The method of claim 9, wherein the step of receiving, from said at least one sensor, measurement information associated with vibrations of said endless track comprises receiving measurement information from measurements performed during a second standstill position, which follows said first standstill position, wherein said tracked vehicle has been moved from said first standstill position to said second standstill position such that the endless track has been rotated so that the portion of the endless track engaged with the ground during said first standstill position is moved so that it, in said second standstill position, is no longer engaged with the ground of said tracked vehicle, during which second standstill said external trigger frequency is applied in connection to said track assembly.

11. The method of claim 9, wherein the step of receiving measurement information from measurements performed during said first and second standstills comprises measurements performed during application of said external trigger frequency by pulsating hydraulic pressure in a tension cylinder in connection to said tension wheel member of said track assembly, said pulsation of hydraulic pressure being within a predetermined frequency sweep from a relatively lower frequency to a relatively higher frequency, said higher frequency being higher than said lower frequency, and back to said relatively lower frequency.

12. The method of claim 9, wherein the step of receiving measurement information from measurements performed during said first and second standstills comprises measurements performed during application of said external trigger frequency by generating oscillations by means of a mechanical device applied on said tension wheel member, said generated oscillations being within a predetermined frequency sweep from a relatively lower frequency to a relatively higher frequency, said higher frequency being higher than said lower frequency, and back to said relatively lower frequency.

13. A device for determining potential damage of an endless track of a tracked vehicle, said tracked vehicle comprising at least one track assembly comprising a drive wheel member, a tension wheel member, a set of road wheels and said endless track disposed in its longitudinal extension around said wheels, said endless track being configured to be rotated by means of said drive wheel member during drive of the tracked vehicle, said device comprising at least one sensor for obtaining measurement information associated with vibrations of said endless track, and at least one processor operatively connected to said at least one sensor, wherein said at least one processor is configured to:
receive, from said at least one sensor, measurement information associated with vibrations of said endless track;
based on the information received from said at least one sensor, determine if there is a natural frequency of said endless track and if so determine the natural frequency of said endless track; and,
based on the determination associated with natural frequency, determine whether or not there is a potential damage to the endless track.

14. The device of claim 13, wherein said at least one processor is configured to determine if there is a natural frequency of said endless track, and if so, determining the natural frequency in the longitudinal extension of said endless track based on the information received from said at least one sensor.

15. The device of claim 13, wherein said endless track comprises a wire configuration arranged within said endless track and configured to run in the longitudinal extension of said endless track around said endless track.

16. The device of claim 13, wherein said at least one processor, when determining whether or not there is a potential damage to the endless track, is configured to:
compare the determination associated with natural frequency of said endless track with a predetermined natural frequency associated with said endless track; and,
determine a potential damage to the endless track if the difference between said determination associated with natural frequency and said predetermined natural frequency exceeds a predetermined threshold.

17. The device of claim 16, wherein said at least one processor, when receiving, from said at least one sensor, measurement information associated with vibrations of said endless track, is configured to receive information from measurement of movement of crankshaft of tension wheel member, and wherein the processor is configured to determine if there is a natural frequency of said endless track, and if so, determining the natural frequency based on said received information about crankshaft movement.

18. The device of claim 16, wherein said at least one processor, when receiving, from said at least one sensor, measurement information associated with vibrations of said endless track, is configured to receive information from measurement of pressure variation of a tension cylinder in connection to said tension wheel member of said track assembly, and wherein the processor is configured to determine if there is a natural frequency of said endless track, and if so, determining the natural frequency based on said received information about pressure variation.

19. The device of claim 13, wherein said at least one processor, when receiving, from said at least one sensor, measurement information associated with vibrations of said endless track, is configured to receive measurement information from measurements performed during a drive sweep of said tracked vehicle, said drive sweep comprising driving said vehicle at a lower speed followed by a higher speed, said higher speed being higher than said lower speed, said higher speed being followed by said lower speed.

20. The device of claim 19, wherein said at least one processor, when receiving measurement information from measurements performed during said drive sweep, is configured to receive measurement information from measurements performed during said sweep performed on predetermined solid ground having an even surface configured to support said tracked vehicle.

21. The device of claim 13, wherein said at least one processor, when receiving, from said at least one sensor, measurement information associated with vibrations of said endless track, is configured to receive measurement information from measurements performed during a first standstill position of said tracked vehicle, during which first standstill position an external trigger frequency is applied in connection to said track assembly.

22. The device of claim 21, wherein said at least one processor, when receiving, from said at least one sensor, measurement information associated with vibrations of said endless track, is configured to receive measurement information from measurements performed during a second standstill position, which follows said first standstill position, wherein said tracked vehicle has been moved from said first standstill position to said second standstill position such that the endless track has been rotated so that the portion of the endless track engaged with the ground during said first standstill has been moved so that it, in said second standstill position, is no longer engaged with the ground of said tracked vehicle, during which second standstill said external trigger frequency is applied in connection to said track assembly.

23. The device of claim 21, wherein said at least one processor, when receiving measurement information from measurements performed during said first and second standstills, is configured to receive said information when said external trigger frequency is configured to be applied in connection to said track assembly by means of pulsating hydraulic pressure in a tension cylinder in connection to said tension wheel member of said track assembly, where said pulsation of hydraulic pressure has been within a predetermined frequency sweep from a relatively lower frequency to a relatively higher frequency, said higher frequency being higher than said lower frequency, and back to said relatively lower frequency.

24. The device of claim 21, wherein said at least one processor, when receiving measurement information from measurements performed during said first and second standstills, is configured to receive said information when said external trigger frequency is configured to be applied in connection to said track assembly by means of generating oscillations by means of a mechanical device applied on said tension wheel member, where said generated oscillations have been within a predetermined frequency sweep from a relatively lower frequency to a relatively higher frequency and back to said relatively lower frequency.

25. A tracked vehicle comprising a device of claim 14.

26. A computer program comprising computer-readable instructions which, when executed by at least one processor of a device for determining potential damage of an endless track of a tracked vehicle, causes the at least one processor to perform the steps of claim 1.

27. A computer program product comprising at least one computer-readable medium, such as a non-volatile memory, storing the computer program of claim 26.
